(19) United States
(12) Patent Application Publication
(10) Pub. No.: US 2015/0011163 A1
(43) Pub. Date: Jan. 8, 2015

(54) Apparatus and Method Using Radio Station Mapping

(71) Applicant: HERE Global B.V., Veldhoven (NL)

(72) Inventor: Kenneth Brazerol, Fargo, ND (US)

(73) Assignee: HERE Global B.V.

(21) Appl. No.: 13/935,648

(22) Filed: Jul. 5, 2013

(51) Int. Cl. H04H 40/27; H04H 60/51; H04H 60/47

(52) U.S. Cl. CPC H04H 40/27; H04H 60/47; H04H 60/51
USPC 455/41.2; 455/182.2; 455/154.1

(57) ABSTRACT

An apparatus including a receiver configured to receive wireless radio station broadcast signals; and a controller including at least one processor, and at least one memory including computer code. The controller is configured with use of the computer code to change a reception frequency of the receiver from a first broadcast radio station transmitting on a first frequency to a second broadcast radio station transmitting on a second different frequency based, at least partially, on location of the apparatus relative to coverage areas of the broadcast radio stations, and at least one substantially common entertainment content attribute of the signals from the first and second broadcast radio stations.

### BACKGROUND

1. Technical Field

The exemplary and non-limiting embodiments relate generally to radio stations and, more particularly, to use of radio station mapping information.

2. Brief Description of Prior Developments

In many metropolitan areas, there are often thirty, forty or even more commercial broadcast radio stations. For working purposes, people in the radio industry have found it convenient to classify radio stations according to certain format genres. Some examples of genres include weather, news, sports, talk, music. Each genre may be sub-divided into many specialty formats of genres. For example, music genre includes country, classic rock, big band, blues, jazz, easy listening, etc.

Mapping of radio station coverage areas without regard to entertainment content or genre is known.

### SUMMARY

The following summary is merely intended to be exemplary. The summary is not intended to limit the scope of the claims.

In accordance with one aspect, an example embodiment is provide in an apparatus comprising a receiver configured to receive wireless radio station broadcast signals; and a controller comprising at least one processor, and at least one memory including computer code, where the controller is configured with use of the computer code to change a reception frequency of the receiver from a first broadcast radio station transmitting on a first frequency to a second broadcast radio station transmitting on a second different frequency based, at least partially, on: location of the apparatus relative to coverage areas of the broadcast radio stations, and at least one substantially common entertainment content attribute of the signals from the first and second broadcast radio stations.

In accordance with another aspect, an example method comprises determining location of a broadcast radio receiver relative to coverage areas of broadcast radio stations; and changing a reception frequency of the receiver from a first broadcast radio station transmitting on a first frequency to a second broadcast radio station transmitting on a second different frequency based, at least partially, on: the determined location; and at least one substantially common entertainment content attribute of the signals from the first and second broadcast radio stations.

In accordance with another aspect, an example embodiment is provided in a non-transitory program storage device readable by a machine, tangibly embodying a program of instructions executable by the machine for performing operations, the operations comprising: determining location of a broadcast radio receiver relative to coverage areas of broadcast radio stations; and determining to change a reception frequency of the receiver from a first broadcast radio station transmitting on a first frequency to a second broadcast radio station transmitting on a second different frequency based, at least partially, on: the determined location; and at least one substantially common entertainment content attribute of the signals from the first and second broadcast radio stations.

### BRIEF DESCRIPTION OF THE DRAWINGS

The foregoing aspects and other features are explained in the following description, taken in connection with the accompanying drawings, wherein:

FIG. 1 is a perspective view of an automobile comprising features of an example embodiment;

FIG. 2 is a diagram illustrating some of the features of the example embodiment shown in FIG. 1;

FIG. 3 is a diagram illustrating broadcast radio stations and mobile or portable device which have broadcast radio station receivers;

FIG. 4 is a diagram illustrating an example of a radio station broadcast coverage area;

FIG. 5 is a diagram illustrating overlap of coverage areas of commercial radio stations;

FIG. 6 is a diagram illustration an example method;

FIG. 7 is a front view of an alternate example embodiment;

FIG. 8 is a diagram illustrating some of the features of the apparatus shown in FIG. 7;

FIG. 9 is a diagram illustrating multiple overlapping radio station broadcast coverage areas identified by genres of broadcast content;

FIG. 10 is a diagram illustrating an example method.

### DETAILED DESCRIPTION OF EMBODIMENTS

Referring to FIG. 1, there is shown a perspective view of an apparatus 10 incorporating features of an example embodiment. Although the features will be described with reference to the example embodiment shown in the drawings, it should be understood that features can be embodied in many alternate forms of embodiments. In addition, any suitable size, shape or type of elements or materials could be used.

The apparatus 10 in this example is a vehicle; namely a car. The car 10 includes an entertainment system 12. The entertainment system may be configured to provide different services such as, for example, playing broadcast radio station music, playing CD music, playing MP3 or MP4 music, playing DVDs, etc. The entertainment system may also be at least partially integrated with other systems of the vehicle including navigation, telephone communications, and vehicle maintenance and vehicle system information display. These are only some examples and should not be considered limiting.

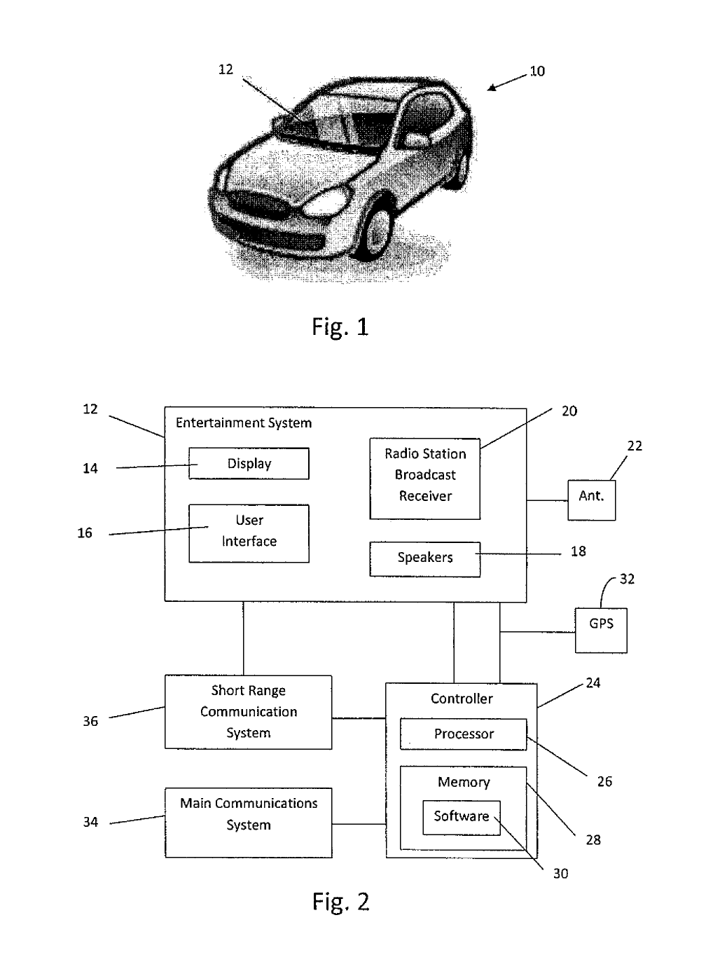

Referring also to FIG. 2, in this example the entertainment system 12 includes an electronic display 14, a user interface 16 (which may comprise a touch input device (TID) as part of the display 14), speakers 18 and a radio station broadcast receiver 20. One or more antenna 22 may be provided for the entertainment system 12. The entertainment system may include other components to provide other features as noted above such as a DVD and/or CD player for example.

In this example the entertainment system is either connected to or comprises a controller 24. The controller 24 comprises at least one processor 26 and at least one memory 28 which includes software or computer code 30. A navigation system 32 such as a GPS (satellite Global Positioning System) for example is connected to the controller 24 and the entertainment system, such as to use the display 14, user interface 16 and speakers 18 for example. In this example the apparatus comprises a main communications system 34 and a short range communications system 36. The main communications system may be configured for wireless telephone and/or Internet communications, such as by use of telephone base stations for example. The short range communications system 36 may comprise a wireless communications system such as BLUETOOTH for example. In an alternate example embodiment the main communications system 34 and/or the short range communications system 36 might not be provided as an on-board, built-in feature of the vehicle 10.

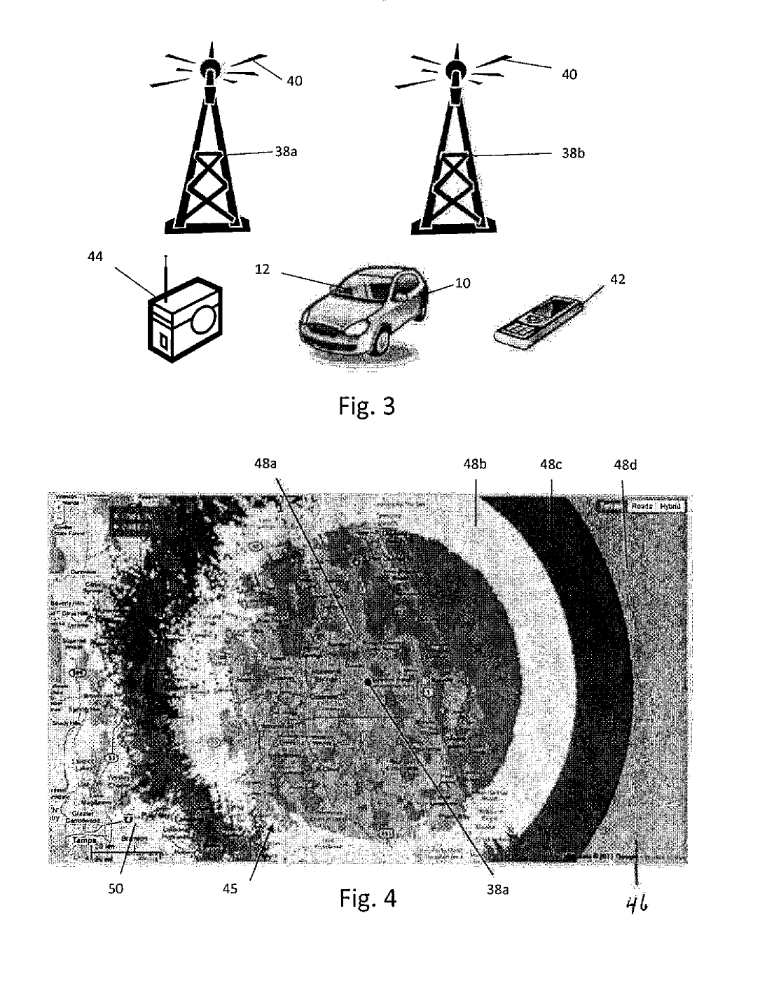

Referring also to FIG. 3, commercial broadcast radio stations 38a, 38b broadcast on different frequencies, but the genre's and/or broadcast content may be the same. The broadcast 40 from each radio station 38, such as an AM or FM transmissions for example, has a coverage area which may be irregular based upon many different factors including power and surrounding terrain or structures (man-made or natural) for example. The broadcast signals 40 may be received by broadcast radio receivers such as the receiver 20 in the car 10, or a receiver in a mobile phone 42, or a receiver in another mobile or portable device 44. As the receiver moves out of the coverage area, the signal is no longer received or lost.

FIG. 4 shows an example of mapping of a coverage area 45 of signals from a single broadcast radio station tower 38a. As can be seen, over the water 46 the signal quality degrades rather uniformly from good 48a, to fair 48b, to poor 48c, to none 48d. However, over the land 50 the degrading of the signal quality is not as uniform because of land based interference.

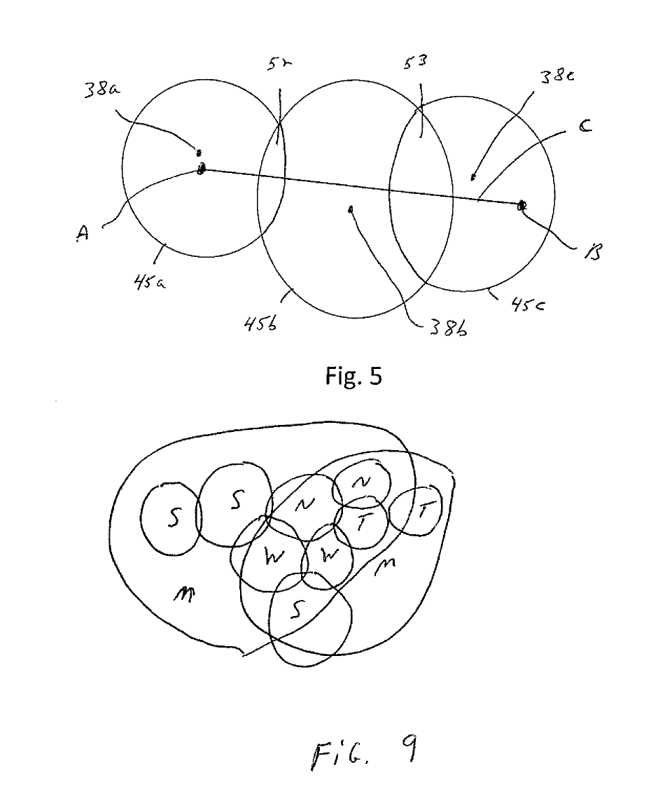

Referring also to FIG. 5, three example coverage areas 45a, 45b, 45c are shown which at least partially overlap each other. As can be seen, the three coverage areas partially overlap at areas 52 and 53. In this example the radio station broadcast signals in the three areas 45a-45c have a same content, such as a nationally syndicated talk show for example. The broadcast signals are transmitted in different frequencies in each of the respective coverage areas 45a-45c. As the vehicle 10 travels from point A to point B along path C, in order to continue to receive the broadcast content, the receiver 20 must change its reception frequency from a first frequency while the vehicle 10 is in coverage area 45a, to a second frequency while the vehicle 10 is in coverage area 45b, and to a third frequency while the vehicle 10 is in coverage area 45c. The third frequency might be the same as the first frequency. While the vehicle 10 is in area 52, the broadcast content may be received when the receiver 20 is tuned to either the first frequency or the second frequency. While the vehicle is in area 53, the broadcast content may be received when the receiver 20 is tuned to either the second frequency or the third frequency.

The vehicle 10 is configured to automatically change the reception frequency or tuning of the receiver 20 as the vehicle travels between locations A and B from the first frequency, to the second frequency, and then to the third frequency based, at least partially, upon the location of the vehicle 10 relative to the coverage areas 45a-45c.

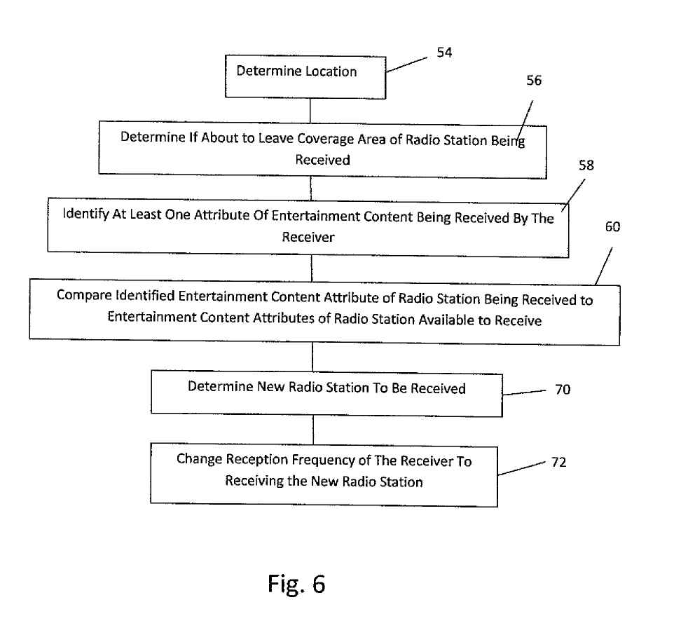

Referring also to FIG. 6, an example method comprises identifying the location of the vehicle 10 having the receiver 20 as indicated by block 54. This may be done, for example, by means of the navigation system 32. As indicated by block 56, the controller 24 is configured to determine if the vehicle 10 is about to leave a coverage area of a radio station being received by the receiver 20. In the example of FIG. 5 with the vehicle 10 starting from the location A, the controller 24 is able to compare the location of the vehicle 10 (and perhaps its general direction of travel along path C) to the coverage area 45a of the radio station 38a being received by the receiver 20. The information regarding the coverage area 45a, such as size, shape and location for example, may be stored in the memory 28. For example, the coverage area information may be stored as a look-up table or downloaded via the Internet with use of the main communication system 34. This may be done based upon an identification of the radio station which the receiver 20 is tuned to.

As indicated by block 58, the entertainment system 12 and the controller 24 are configured to identify at least one attribute of the entertainment content being received by the receiver 20. This attribute(s) may comprise, for example:
a genre of broadcast content,
a particular song or performer,
a broadcast content programming, such as a particular syndicated talk show or music program for example which is played by multiple radio stations at a same time, and/or
information which identifies a rebroadcast online streaming which is played by multiple radio stations at a same time.

The different types of attributes may be prioritized relative to each other. For example, broadcast content programming, such as a particular syndicated talk show or music program may have priority over a genre of broadcast content.

As the vehicle moves from fair signal area 48b into poor signal area 48c, the controller 24 is configured to use the at least one attribute to compare the identified entertainment content attribute of the radio station 38a being received to entertainment content attributes of other radio stations available to be received on other frequencies as indicated by block 60. The information regarding other radio stations available to be received is based upon the vehicle's current location (and perhaps direction of travel). The information regarding the entertainment content attributes of these other radio stations may be downloaded via the Internet with use of the main communication system 34, or perhaps obtained from broadcasts of the radio stations themselves if the receiver scans through the radio stations. The receiver may comprise dual or multi- receivers for this scanning purpose for example.

In the example of FIG. 5, the second radio station 38b is broadcasting the same entertainment content as the first radio station 38a. Thus, as indicated by block 70 the controller 24 is able to determine that the second radio station may be the new radio station to be received or tuned to in order to continue to receive the same entertainment content as the receiver 20 had been receiving from the first radio station 38a. As indicated by block 72, the controller 24 may then automatically cause the receiver 20 to change the reception frequency from the first frequency of the first broadcast radio station to the second different frequency of the second broadcast radio station. A similar sequence of method may occur as the vehicle moves from coverage area 45b into coverage area 45c.

Referring also to FIG. 9, an example diagram is shown of multiple radio station coverage areas with an indication of genre of broadcast content as follows:
S=Sports
W=Weather
N=News
T=Talk
M=Music
   The same method described above with regard to content may be used in regard to genres where the receiver will be automatically switched to a frequency of a new radio station as the vehicle is about to leave a first radio station coverage area. In an instance where there is no same or similar genre, the system may default to not attempting to change the reception frequency, and perhaps notify the user. The user may then change the receiver to receive a new radio station manually. Some genres have similarities. For example, rock & roll music includes genres in the radio station industry such as active rock, album rock, alternative rock, classic rock, mainstream rock, modern rock, progressive rock, psychedelic rock, soft rock. The system may be configured to prioritize selection from among these similar genres if an exactly same genre is not available. This is merely an example, and this type of alternative automatic selection of a similar genre may be applied to other genres. Mapping of radio station coverage areas with regard to content and/or genre any also be provided and used by the vehicle 10.

Features of an example embodiment as described herein relate to signals from commercial radio stations which would not be considered to have “interactive” switching with the commercial broadcast radio receiver. The commercial broadcast radio stations merely transmit or broadcast signals. The commercial broadcast radio stations do not otherwise interact with the radio receivers.

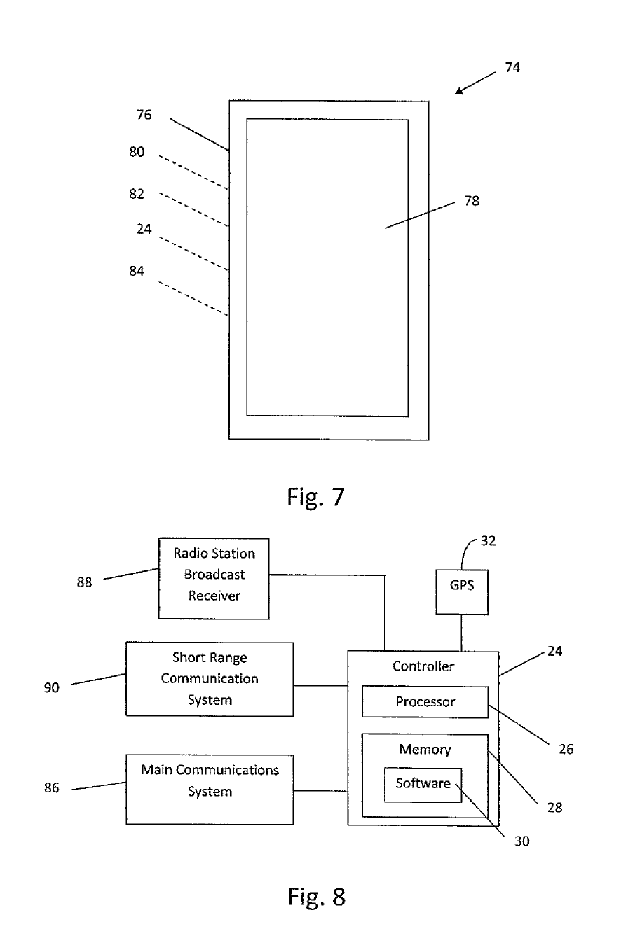

Referring also to FIG. 7, the features as describe herein are not limited to an on-board broadcast radio receiver of a vehicle. FIG. 7 shows an apparatus 74 which is a hand-held portable apparatus, such as a communications device which includes a telephone application for example. In the example shown the apparatus 74 is a smartphone which includes a FM radio reception capability. The apparatus 74 may additionally or alternatively comprise an Internet browser application, a video recorder application, a music player and recorder application, an email application, a navigation application, a gaming application, a camera and camera applications, and/or any other suitable electronic device application. In an alternate example embodiment the apparatus might not be a smartphone.

Referring also to FIGS. 8, the apparatus 74, in this example embodiment, comprises a housing 76, a touchscreen 78, a wireless telephone receiver 80, a wireless telephone transmitter 82, a controller 24, and a rechargeable battery 84. However, all of these features are not necessary to implement the features described below. The controller 24 may include at least one processor 26, at least one memory 28, and software 30. The electronic circuitry inside the housing 76 may comprise at least one printed wiring board (PWB) having components such as the controller 24 thereon. The receiver 80 and transmitter 82 form a primary communications system 86 to allow the apparatus 74 to communicate with a wireless telephone system, such as a mobile telephone base station for example. The apparatus 74 also comprises a broadcast radio station receiver 88 and a short range communications system 90. The apparatus has a navigation locator 32 such as a GPS for example.

The apparatus 74 is able to function the same as described above except instead of using the receiver 20 to play the content from the radio stations, the radio station signals are received by the receiver 88 and played by either the apparatus 74 or communicated by the short range communication system 90 to the short range communications system 36 (or perhaps a direct removable wired connection) and played by the entertainment system 12. In another alternate example, the apparatus 74 would not have the receiver 88. However, the apparatus 74 would have the ability to perform the method shown in FIG. 6 to control automatic changing of the radio station tuning by the receiver 20 by a link through the short range communication systems 36, 90 (or a directed removable wired connection).

When traveling long distances, such as in an automobile or train for example, searching for a radio station can be frustrating and perhaps dangerous. For a driver of an automobile, searching for a radio station on an on-board vehicle radio system may take the attention of the driver away from driving the car, such as when a driver scans channels multiple times through commercials to find what the driver wants to listen to. Also, listening to a CD or MP3 player in a car keeps a driver out of touch with local news/weather. Having a way to easily find/or automatically change a broadcast radio station when needed to programing may be provided with features as described herein.

Mapping the radio station coverage areas along with programming attributes, such as station genre (Top 40, Country-Western, Sports Talk, Classic Rock, etc.) and national syndicated programming i.e. (Ryan Secrest, Rush Limbaugh, etc.) would allow an in-car audio platform to automatically tune into a broadcast radio station when the car gets out of range of an original radio station. Also, online streaming information may be accessed as an attribute to allow the future Connected Car to connect digitally in the future. In addition, mobile phone applications may be created to support this functionality through BLUETOOTH connection to in-car stereos FOR example.

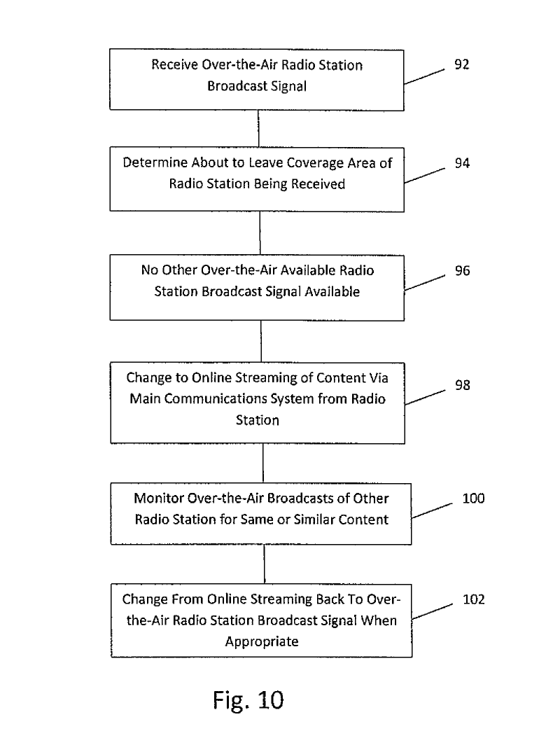

Referring also to FIG. 10, an example method is shown where the receiver 20 is initially receiving an over-the-air broadcast signal from a radio station as indicated by block 92. When the system determines that the receiver 20 is about to leave the coverage area of the radio station as indicated by block 94 (or if the signal is otherwise poor), but the system determines that no other over-the-air broadcast of the same or similar content is available as indicated by block 96, the system is configured to change to online streaming of the content from the radio station via the Internet and use of the main communications system 34 to access the Internet as indicated by block 98. The system may monitor the over-the-air broadcasts of other radio stations for a same or similar content as indicated by block 100, and change back to over-the-air signal reception from a new commercial radio station after it has been identified as indicated by block 102. This can allow the user to continue to receive the entertainment content by switching between commercial radio stations broadcasts and online streaming via the Internet. The switching may be automatic based upon signal quality of the commercial radio stations broadcasts, and whether or not any other commercial radio stations broadcasts are available for reception having the same or similar content.

Mapping of radio station coverage areas could be represented as a coverage area within the Core Map product of Nokia Corporation for example. Or it could be represented as a look-aside table to supplement the Core-Map product. Applications could be directly integrated into a Connected Car which could take advantage of this technology or platform. A Connected Car is an automobile that is equipped with internet access, and usually also with a wireless local area network. This allows the automobile to share internet access to other devices, both inside as outside the vehicle. Often, the automobile is also outfitted with special technologies that tap into the internet access or wireless LAN and provide additional benefits to the driver. Examples include automatic notification of crashes, notification of speeding, etc. Increasingly, Connected Cars (and especially electric cars) are taking advantage of the rise of Smartphones, and apps are available to interact with the car from any distance. For example, users can unlock their cars, check the status of batteries on electric cars, find the location of the car, or remotely activate the climate control system.

With features as described herein, through a Connected Car the driver could stream FM radio or online streaming services where applicable. Platform applications could be created for mobile phones to connect to in-car stereos through Bluetooth or wired connection which would stream on-line streaming radio station feeds or FM signals. Advantages include Hands Free radio adjustments, Connected Car compatibility, and/or mobile phone applications.

In one example embodiment, an apparatus 10 or 74 comprises a receiver configured to receive wireless radio station broadcast signals; and a controller comprising at least one processor, and at least one memory including computer code, where the controller is configured with use of the computer code to change a reception frequency of the receiver from a first broadcast radio station transmitting on a first frequency to a second broadcast radio station transmitting on a second different frequency based, at least partially, on: location of the apparatus relative to coverage areas of the broadcast radio stations, and at least one substantially common entertainment content attribute of the signals from the first and second broadcast radio stations.

The apparatus may be a hand-held portable electronic apparatus, or a vehicle for example. The apparatus may further comprise a locator configured to determine the location the apparatus. The controller may be configured to determine when the apparatus is about to move out of the coverage area of the first broadcast radio station. The apparatus may be configured to compare at least one entertainment content attribute in the signals from the first broadcast radio station to at least one entertainment content attribute in the signals from the second broadcast radio station. The entertainment content attribute may comprise at least one of: a genre of broadcast content, broadcast content programming, and rebroadcast online streaming information. The apparatus may comprise a short range communication system configured to transmit the broadcast signals received by the receiver from the apparatus to another device. The apparatus may comprise a look-up table comprising coverage area information of the broadcast radio stations. The apparatus may be configured to determine at least one of the following regarding broadcast content in the signals from the first and second broadcast radio stations: a genre of broadcast content, broadcast content programming, and rebroadcast online streaming information. The apparatus may further comprise an electronic display connected to the controller; a printed wiring board connected to the display; a battery connected to the printed wiring board; and an antenna connected to the printed wiring board. The apparatus may comprise means for automatically changing tuning of the receiver from the first frequency to the second frequency when the apparatus is about to leave the coverage area of the first broadcast radio station.

An example method may comprise determining location of a broadcast radio receiver relative to coverage areas of broadcast radio stations; and changing a reception frequency of the receiver from a first broadcast radio station transmitting on a first frequency to a second broadcast radio station transmitting on a second different frequency based, at least partially, on: the determined location; and at least one substantially common entertainment content attribute of the signals from the first and second broadcast radio stations.

The method may further comprise determining when the receiver is about to move out of the coverage area of the first broadcast radio station. The method may further comprise comparing at least one of the entertainment content attribute(s) in the signals from the first broadcast radio station to at least one of the entertainment content attribute(s) in the signals from the second broadcast radio station. The entertainment content attribute comprises at least one of: a genre of broadcast content, broadcast content programming, and rebroadcast online streaming information. The method may further comprise transmit the broadcast signals received by the receiver from the apparatus to another device by a short range communication system. The method may further comprise determining coverage area information of the broadcast radio stations with a look-up table.

Another example may be provided in a non-transitory program storage device readable by a machine, tangibly embodying a program of instructions executable by the machine for performing operations, the operations comprising: determining location of a broadcast radio receiver relative to coverage areas of broadcast radio stations; and determining to change a reception frequency of the receiver from a first broadcast radio station transmitting on a first frequency to a second broadcast radio station transmitting on a second different frequency based, at least partially, on: the determined location; and at least one substantially common entertainment content attribute of the signals from the first and second broadcast radio stations.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
a receiver configured to receive wireless radio station broadcast signals; and
a controller comprising at least one processor, and at least one memory including computer code,
where the controller is configured with use of the computer code to change a reception frequency of the receiver from a first broadcast radio station transmitting on a first frequency to a second broadcast radio station transmitting on a second different frequency based, at least partially, on:
location of the apparatus relative to coverage areas of the broadcast radio stations, and
at least one substantially common entertainment content attribute of the signals from the first and second broadcast radio stations.

2. An apparatus as in claim 1 where the apparatus is:
a hand-held portable electronic apparatus, or
a vehicle.

3. An apparatus as in claim 1 where the apparatus further comprises a locator configured to determine the location the apparatus.

4. An apparatus as in claim 1 where the controller is configured to determine when the apparatus is about to move out of the coverage area of the first broadcast radio station.

5. An apparatus as in claim 1 where the apparatus is configured to compare at least one entertainment content attribute in the signals from the first broadcast radio station to at least one entertainment content attribute in the signals from the second broadcast radio station.

6. An apparatus as in claim 1 where the entertainment content attribute comprises at least one of:
a genre of broadcast content,
broadcast content programming, and
rebroadcast online streaming information.

7. An apparatus as in claim 1 where the apparatus comprises a short range communication system configured to transmit the broadcast signals received by the receiver from the apparatus to another device.

8. An apparatus as in claim 1 where the apparatus comprises a look-up table comprising coverage area information of the broadcast radio stations.

9. An apparatus as in claim 1 where the apparatus is configured to determine at least one of the following regarding broadcast content in the signals from the first and second broadcast radio stations:
a genre of broadcast content,
broadcast content programming, and
rebroadcast online streaming information.

10. An apparatus as in claim 1 further comprising:
an electronic display connected to the controller;
a printed wiring board connected to the display;
a battery connected to the printed wiring board; and
an antenna connected to the printed wiring board.

11. An apparatus as in claim 1 comprising means for automatically changing tuning of the receiver from the first frequency to the second frequency when the apparatus is about to leave the coverage area of the first broadcast radio station.

12. A method comprising:
determining location of a broadcast radio receiver relative to coverage areas of broadcast radio stations; and
changing a reception frequency of the receiver from a first broadcast radio station transmitting on a first frequency to a second broadcast radio station transmitting on a second different frequency based, at least partially, on:
the determined location; and
at least one substantially common entertainment content attribute of the signals from the first and second broadcast radio stations.

13. A method as in claim 12 further comprising determining when the receiver is about to move out of the coverage area of the first broadcast radio station.

14. A method as in claim 12 further comprising comparing at least one of the entertainment content attribute(s) in the signals from the first broadcast radio station to at least one of the entertainment content attribute(s) in the signals from the second broadcast radio station.

15. A method as in claim 12 where the entertainment content attribute comprises at least one of:
a genre of broadcast content,
broadcast content programming, and
rebroadcast online streaming information.

16. A method as in claim 12 further comprising transmit the broadcast signals received by the receiver from the apparatus to another device by a short range communication system.

17. A method as in claim 12 further comprising determining coverage area information of the broadcast radio stations with a look-up table.

18. A non-transitory program storage device readable by a machine, tangibly embodying a program of instructions executable by the machine for performing operations, the operations comprising:
determining location of a broadcast radio receiver relative to coverage areas of broadcast radio stations; and
determining to change a reception frequency of the receiver from a first broadcast radio station transmitting on a first frequency to a second broadcast radio station transmitting on a second different frequency based, at least partially, on:
the determined location; and
at least one substantially common entertainment content attribute of the signals from the first and second broadcast radio stations.
